(19) United States
(12) Patent Application Publication
(10) Pub. No.: US 2015/0356526 A1
(43) Pub. Date: Dec. 10, 2015

(54) Intuitive Interactive Automated Video Teller Machine

(71) Applicant: Mark Christmas, Hampton, GA (US)

(72) Inventor: Mark Christmas, Hampton, GA (US)

(21) Appl. No.: 14/298,896

(22) Filed: Jun. 7, 2014

(51) Int. Cl. G06Q 20/10

(52) U.S. Cl. CPC G06Q 20/1085; G06Q 40/02

(57) ABSTRACT

Disclosed is an inventive concept in the field of automated teller machines, frequently referred to as ATM's. The concept, referred to as a “micro-branch,” comprises a method of presenting a sequence of automated, interactive video presentations to a user who then performs desired financial transactions. In particular, the disclosed concept relates to a free-standing kiosk that can perform a plurality of financial transactions which, up to now, were only available at the main office or a branch office of the financial institution. The preferred embodiment of this concept is the design of a system specifically applicable to a credit union and its members, although similar transactions may be engaged in by customers of banks and other financial institutions. The functional characteristics of the concept include the user's selection of varied video “concierges” to provide intuitive-type assistance to the user of the system.

### CROSS-REFERENCES TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

(1) Field of the invention

The inventive concept disclosed is in the field of automated teller machines, frequently referred to as ATM's. In particular, the disclosed concept relates to a free-standing kiosk that can perform a plurality of financial transactions that up to now, were only available at the office or branch office of a user desiring the unique transactions. The preferred embodiment of this concept is the design of a system specifically applicable to a credit union and its members, wherein the kiosk is referred to as a “micro-branch.” The functional characteristics of the concept are based on a kiosk-type structure operable by automated, interactive video presentations.

(2) Description of the Related Art, including information disclosed under 37 CFR 1.97 and 1.98.

The following documents disclose sonic features and/or components that are similar to the inventive device in this application.

U.S. published patent application #2003/0217005 (November, 2003); A system and method of providing an electronic transaction receipt from a cash dispensing ATM. A bank host computer is operable to submit the receipt to a system address of record with the bank. The address of record corresponds to an e-mail address, phone number or other address associated with an account involved in the transaction. The receipt may include an image or images associated with the transaction. Thus, a user of an ATM is able to receive an electronic receipt corresponding to the ATM transaction. The system may also operate to image deposited checks deposited at an ATM. Copies of the imaged checks and other information can be electronically sent to a maker, payee, a clearinghouse or banks involved with the transaction. The system may also operate to provide the user with blank checks in hard copy or virtual checks for transactions

U.S. published patent application #2013/0048713 (February 2013). A voice prompt method includes obtaining an image of a user and storing the obtained image as a characteristic. image when users successfully log onto an automated teller machine; taking photographs of the location surrounding the automated teller machine at predetermined time intervals to obtain real-time images; judging whether the person of the characteristic image is the same as the person in the real-time image; and generating a voice prompt to remind the user not to forget to remove his/her bank card if the distance between the user and the automated teller machine becomes larger than a predetermined value. An automated teller machine is also provided.

U.S. published patent application #2005/0097037 (May 2005); An electronic transaction verification system for use with transaction tokens such as checks, credit cards, debit cards, and smart cards that gathers and transmits information about the transaction token and biometric data. The system preferably has the ability to read or scan transaction and account information printed or encoded on the transaction token, digitally encode biometric data, scan drivers' licenses or other identification cards, and take a signature of a customer, all at a transaction location for purposes of account verification. The electronic verification system includes a biometric data device for recording and/or transmitting biometric data taken at the transaction location. The electronic transaction verification system can be used in conjunction with a tokenless transaction processing system to determine if the token presented for payment is associated with an account established for an authorized user that has registered with the tokenless transaction processing system

U.S. Pat. No. 7,191,936 (March, 2007); Disclosed is an automated teller machine (10) which comprises a fascia (12) having a check entry/exit slot (56), and a check processing module (60) for processing checks entered via the slot (56). The terminal (10) includes a control means (86), biometric data capture means (112, 156, 158), a printer (74) and a check transport mechanism (70) for transporting checks between the slot (56) and the printer (74). The control means is arranged to cause the printer (74) to print a representation of a biometric characteristic of a user onto a check during an attempt to deposit the check in the terminal (10).

### BRIEF SUMMARY OF THE INVENTION

The inventive concept is rooted in a specially-configured kiosk 7 which performs as a “micro branch” 40 and interacts with a user 30 by means of a proprietary interactive video technology, in the form of “ELLA,” 28 a personalized icon that guides a user 30 through his/her desired financial transactions.

The disclosed inventive concept, commercially named “Mosaic Silhouette,” or “Silhouette,” 1 is a remote, stand-alone teller machine providing substantially all financial services which could be offered in person at the financial institution which owns the teller machine. The Silhouette 1 system utilizes a specialized software solution entitled “Mosaic,” and is integrated with powerful technologies. The teller machine, or kiosk 7 comprises an automated micro-branch 40 that functions as a full service branch location for customers of the financial institution. The financial institution is equipped with a Mosaic front-end server 2, 33 (see FIGS. 1, 2, and 3) which receives inputs from in-branch members of the financial institution, micro branches 40, and also customers via the internet 5.

The preferred embodiment of the invention is a kiosk 7 having a footprint of approximately four square feet and weighing less than 350 pounds with all of the unit's hardware installed. However, the micro-branch 40 need not be a kiosk but may also comprise any of a variety of shapes and profiles, including a built-in wall unit. An industry standard UL-rated safe is also included as a component of the machine.

### BRIEF DESCRIPTION OF THE VIEWS OF THE DRAWINGS

FIG. 1 presents a schematic layout of the basic working configuration of the Silhouette 1. operational system which supports operation of the micro-branches 40.

FIG. 2 illustrates a simplified client/server model indicating the function of the Mosaic from-end server 33 in the DMZ 32.

FIG. 3 is an expanded presentation of the various relationships among the departments and components of a typical credit union, as well as third-party interacting entities, technological equipment, software systems, and primary servers.

FIG. 4 is the frontal view of a typical model of the kiosk 7 used in a micro branch 40.

FIG. 5 illustrates a stylized rendering of a user 30 approaching a micro branch kiosk 10.

FIG. 6 depicts a rear view of the kiosk 7 and the placement of operational panels.

FIG. 7 shows the relative arrangement of basic equipment that may be installed in a micro branch 40 kiosk 7.

FIG. 8 is an expanded view of a preliminary display menu 15 appearing in conjunction with the concierge 29, and as guided by ELLA 28.

FIG. 9 presents a flow chart depicting the initial stages tracing the initial demographic concierge 29 selection and the method of establishing authentication and/or identity of a user 30.

FIG. 10 is a flow chart showing the process of sequential steps engaged in by a user 30 selecting the appropriate video concierge 31 for performance of the desired financial transaction(s).

### DETAILED DESCRIPTION OF THE INVENTIVE CONCEPT

The objects, features, and advantages of the concept presented in this application are more readily understood when referring to the accompanying drawings. The drawings, totaling ten figures, show the basic components and functions of embodiments and/or methods of use. In the several figures, like reference numbers are used in each figure to correspond to the same component as may be depicted in other figures.

In its preferred embodiment, the Silhouette 1 system is utilized by a credit union 6 to provide remote financial services to its members. However, the underlying operating technology is applicable to banks, savings and loans institutions, and other business entities providing similar financial services to their customers. For the sake of clarity and ease of explanation in this disclosure, and without placing any limitations or restrictions on the capabilities of the invention., the functions of the inventive concept will be referenced primarily to its use by a credit union 6 and its members.

As a point of reference, the customer of a bank or other financial institution. will be afforded essentially the same functional transactions as would be presented to a member of a credit union 6 utilizing the Silhouette 1 system, Most of the transactions of the Silhouette 1. system are contingent on the accessibility of the “core” system of the financial institution as availed through a compatible application programming interface (API). By reference to a “core” system it is understood that a financial institution, particularly a credit union, functions from a core platform, or data processing system, that controls transaction protocol system-wide.

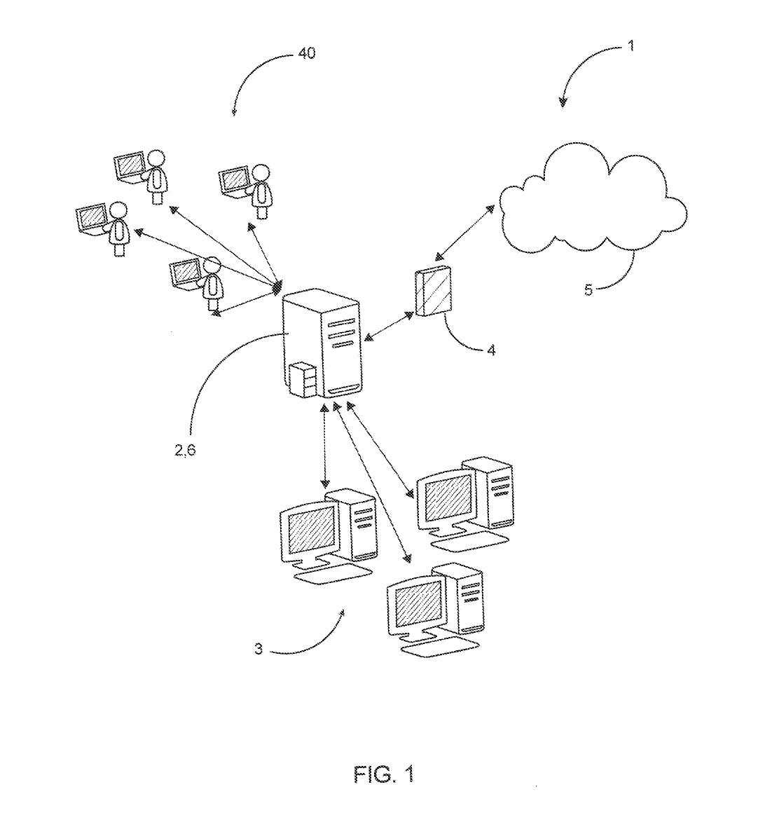

The discussion of the inventive concept begins with FIG. 1, wherein is illustrated the basic configuration of the Silhouette I operating system. At the main office of a credit union 6 a Mosaic primary server 2 is installed which provides all processing functions for in-branch users 3 of the financial institution and also for the users of the micro branches 40 at various locations, The Mosaic primary server 2 further provides processing functions for internet 5 customers of the credit union 6.

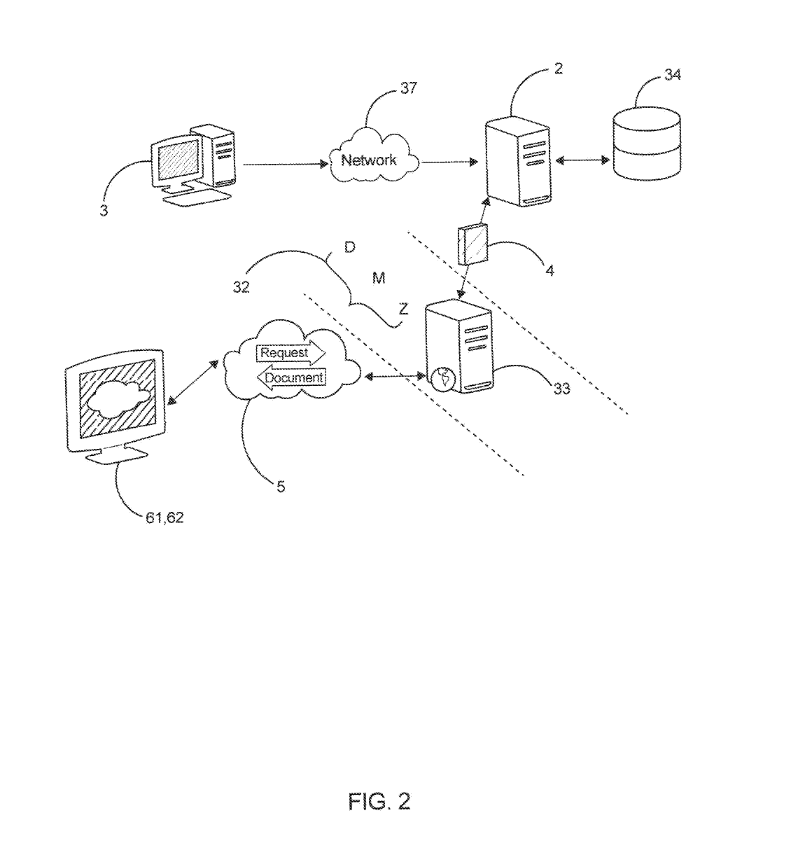

FIG. 2 illustrates what is referred to in computer security terminology, as a “DMZ” 32 (“Demilitarized Zone,” or a supplemental “perimeter network.)” In the present disclosure, the DMZ 32 is an electronic and physical sub-network of equipment and circuits that exposes the external interfacing services of a financial institution e.g., a credit union to a larger, unpredictable, and unsecure network, predominantly the Internet 5. The DMZ 32 serves to add an additional layer of security to the financial institution's local area network 37. A hacker, virus, or other external attacker is only able to directly access the financial institution's equipment in the DMZ 32, rather than its local area network 37.

FIG. 2 further depicts the fact that the Mosaic Silhouette 1 system is designed with a Mosaic front-end server 33 exposed in the DMZ 32. The Mosaic front-end server 33, upon receipt of communications from the Internet 5, as fed into the DMZ 33, routs such communications traffic to a firewall 4, The firewall 4 is a software-based security system that analyzes the incoming Internet 5 traffic and the associated data packets to determine whether the communications should be allowed into the Mosaic primary server 2. The Mosaic primary server 2 then communicates freely and directly with at least one Mosaic database 34 and the local area network 37 to “in-house” clients 3.

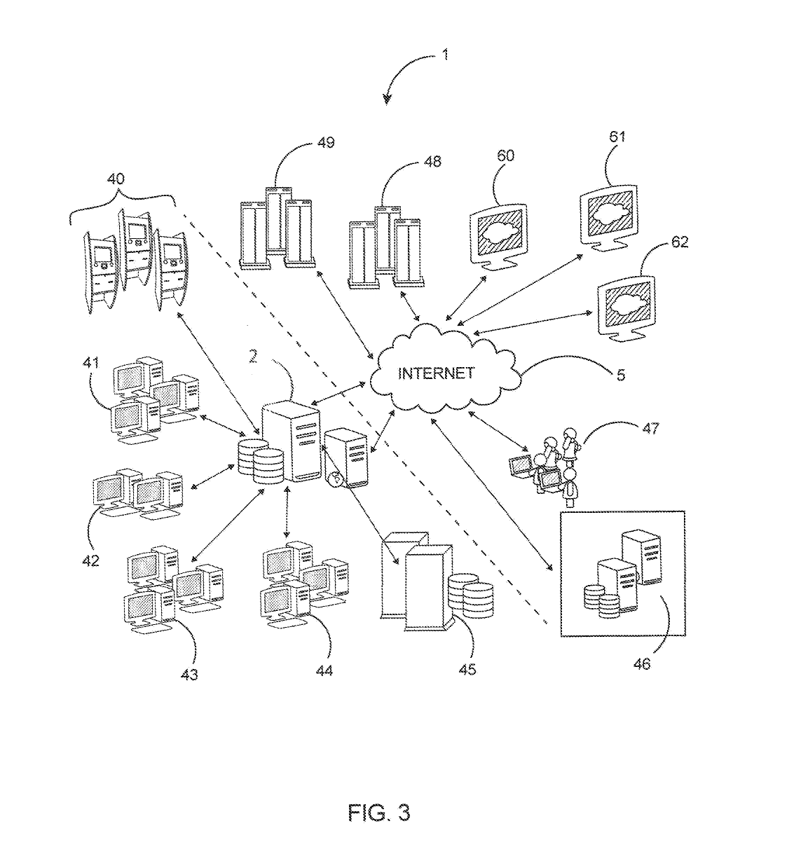

FIG. 3 illustrates an overall summary of the extensive integration of the Mosaic primary servers 2 of the Silhouette 1 system with not only the micro branches 40, but other entities and functions, including a credit union call center 41, credit union administrators 42, processors, Member Service Representatives (MSRs) and Field Service Representatives (FSRs) 43, underwriters 44, and, in this illustration, a SYMITAR/EPISYS® 45 processing, system. Symitar® 45 is the leading provider of integrated computer systems and information processing solutions for credit unions of all sizes. The Silhouette 1 operating system utilizes its own proprietary application programming interface (API) to interface with Symitar® or other core computer system a credit union 6 or other financial institution may be using.

Further, as shown in FIG. 3, the Silhouette 1 system, via direct internet 5 connections, accesses off-site backup servers 46, eBranch technology 47, credit bureaus 48, and third-party vendors 49. Examples of functions performed by the Mosaic primary servers 2 include indirect lending 60. WEB-based loan applications 61, and WEB-based member applications 62.

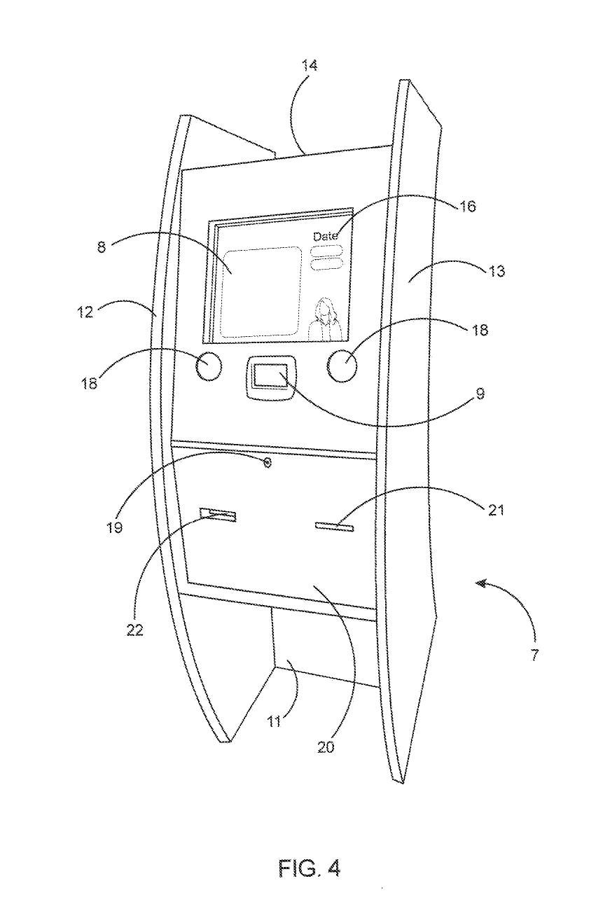

In viewing FIG. 4, there is shown a frontal view of a typical kiosk 7, which is the heart of the micro-branch 40. Functional components of the kiosk 7 may include, but are limited to, a monitor 8, an optical ID scanner 9, a printer discharge slot 21, a scanner input slot 22, and speakers 18. Depending on the particular use required by a financial institution, other components may be installed with the kiosk 7, such as a bill acceptor, a cash dispenser, magnetic ink character recognition (MICR), signature pads for supporting electronic signatures, and a video surveillance camera. Structural components of the kiosk 7 are a left panel 12, a right panel 13, an upper panel 14, a back panel 11, and a front access door 20 which is normally maintained secure by a lock 19. A micro-branch 40 kiosk 7 need not be in the shape and configuration as shown in FIG. 4, but may comprise various shapes, styles, and sizes, and may even be wall-mounted.

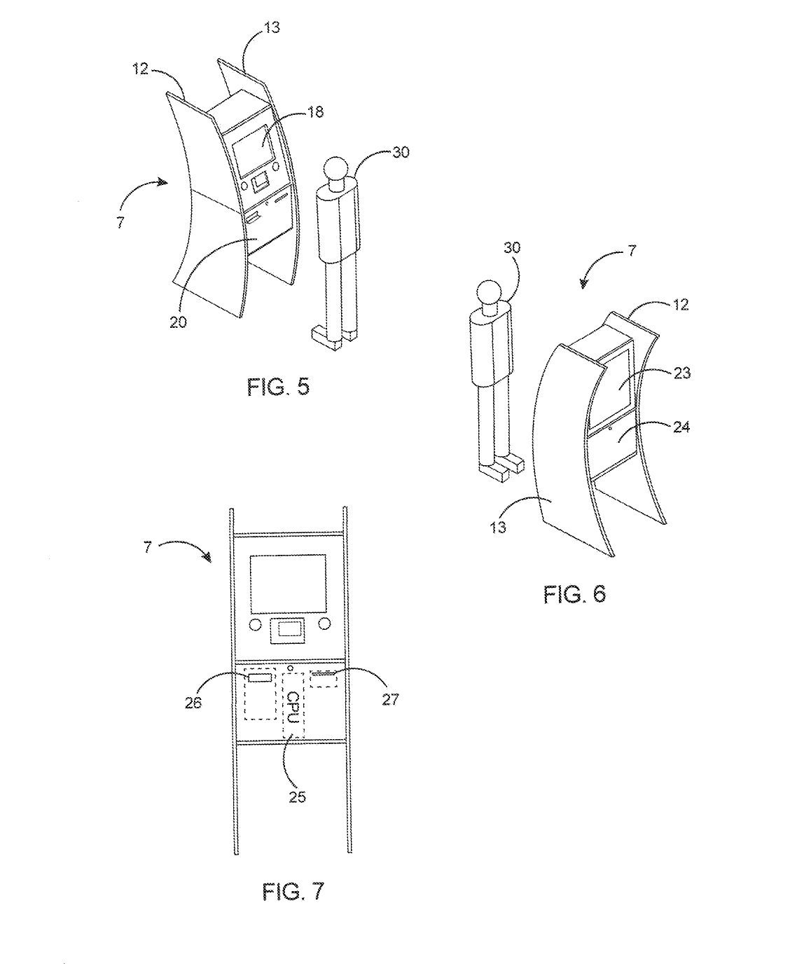

FIG. 5 presents a general sketch of the relative sites and position of a user 30 upon approaching a kiosk 7. FIG. 6 illustrates the rear of the kiosk 7, further showing a rear upper access door 23 and a rear lower access door 24, both of these access doors 23, 24 normally maintained closed and locked FIG. 7 depicts the general arrangement of a scanner 26, central processing unit (CPU) 25, and a printer 27, all internal to the kiosk 7.

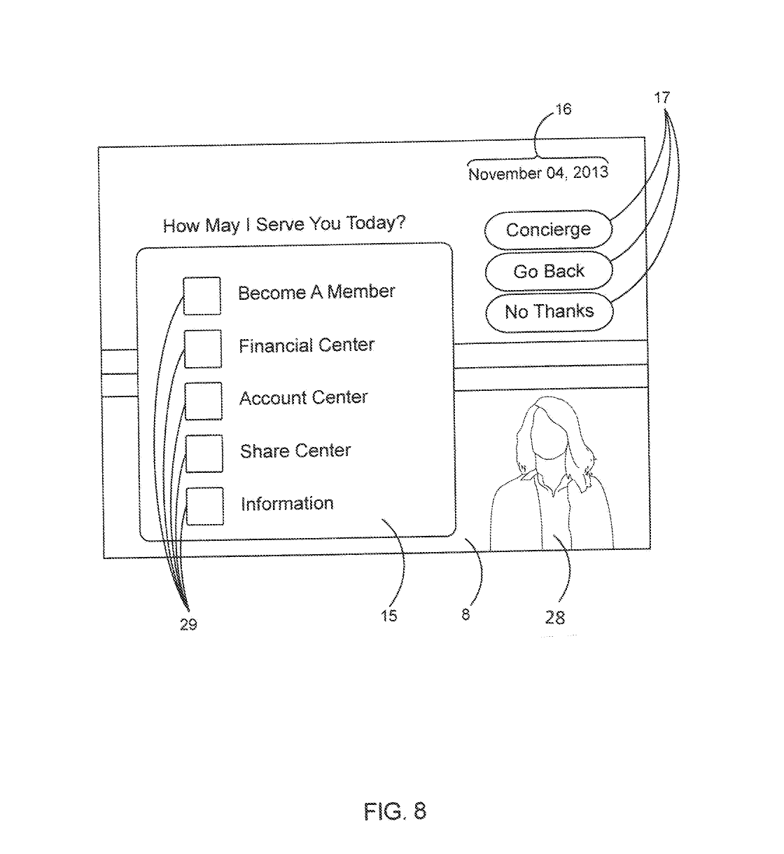

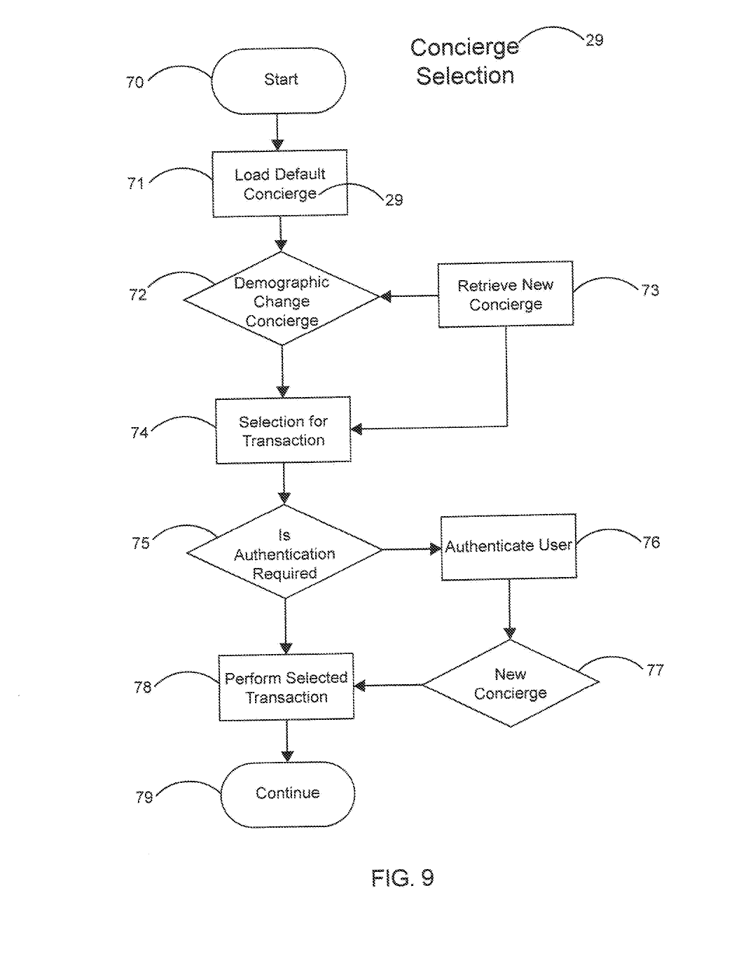

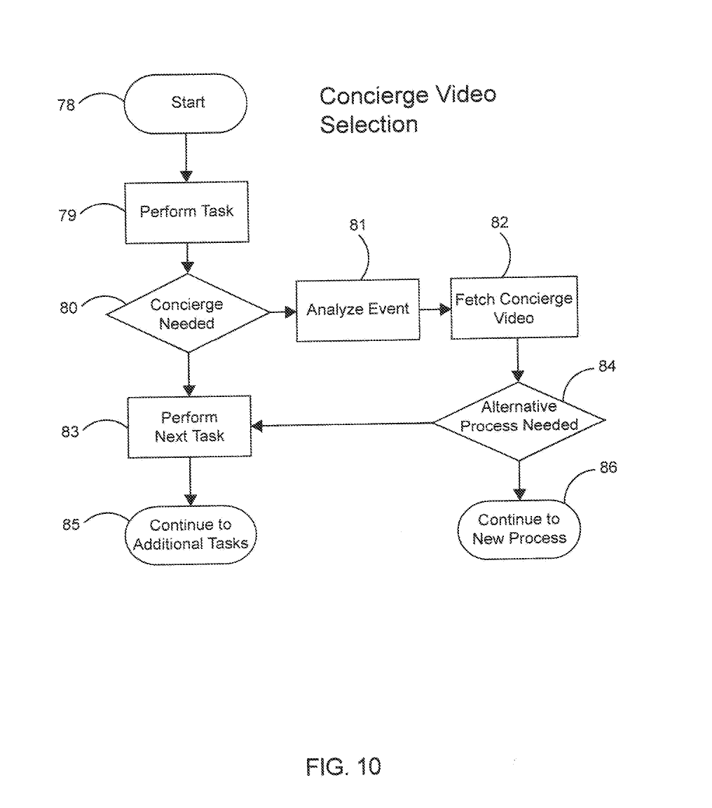

Again referring to FIG. 4, upon approaching the kiosk 7 a user 30 must initiate steps on the touch-screen monitor 8 to prompt the micro-branch 40 to sequentially display windows 15 which are used to authenticate and/or identify the user 30. Once a user 30 is authenticated, the Mosaic Silhouette 1 then presents a screen inquiry comprising command messages 17 enabling the user 30 to select a “concierge” 29 (as shown in FIG. 8) to guide him/her through the desired financial transactions.

Essentially, a concierge 29 is to identify a personality or character which is shown in the initial videos displayed on the touch-screen monitor 8. A typical rendering of a personality is shown in FIG. 8. The inventive concept matches a set of transactional videos with a specific concierge 29 (or personality) displayed to the end user 30. As an example, a user 30 having a primary demographic of a speaker of the Spanish language approaches a kiosk 7 and, by initial touch-screen prompts, it is determined that the video selections will be automatically switched to a concierge 29 that. communicates in the Spanish language with regard to the concierge 29 selections. The user 30 may also make this switch manually by following prompts on the touch-screen monitor 8.

The Silhouette 1 micro-branch 40 can perform a myriad of financial transactions, which exceed the number and availability of similar types of transactions available by automated teller machines found in the prior art. A micro-branch 40 may be customized by a particular financial institution to include several optional functions including teller-assisted transactions, selection of a video-interactive concierge 31 for guidance through certain financial transactions, telephonic communications with the financial institution main branch, management of the layout of bow a user's 30 account is displayed, “shortcut” transactions utilizing only one display panel, and user 30 interfacing to standard mobile devices While waiting in line The micro branch 40 supports and enables a user 30 to perform the following transactions:

Among the financial transactions performable at a micro-branch 40, using the specific example of a credit union 6, are the following:
(a) Cash deposits, which are supported utilizing an MEI® bill acceptor at the micro-branch 40, and in conjunction with the application programming interface (API) within the core system of the credit union 6;
(b) Cash withdrawals are performed utilizing a cash dispenser manufactured by Genmega©, and further interfacing with an API to the core system of the credit Union 6;
(c) Check deposits may be accomplished by means of a Hantle® Check. Scanner to capture front and back of the check, which also requires interfacing with an API to the core system of the credit union 6;
(d) Cashier check disbursement is supported using a printer capable of managing the paper stock and a magnetic ink character recognition (MICR) device;
(e) Loan Payments are handled in conjunction with the API interfacing with the core system of the credit union 6;
(f) Funds transfer between member sub-accounts is supported by means of the API within the core system of the credit union 6:
(g) Stop payment (check) is performed via the API within the core system of the credit union 6;
(h) Stop payment (automated clearing house or ACH) is supported via the API within the COM system of the credit union 6;
(i) Account balance inquiries function is supported via the API within the core system of the credit union 6;
(j) Loan balance inquiries are supported via the API within the core system of the credit union 6;
(k) Signatures for any required documents are supported either through the use of Mollie signature pads or through a standard identified by a specific credit union 6 for support of electronic signatures
(l) Loan origination and decision: utilizing, the policies set by the credit union 6, Mosaic Silhouette 1 can originate any loan type specified by the credit union 6. By using either software incorporated within Mosaic 1 or a decision tool supported via the API of the core system of the credit union 6, the member can receive a “real time” decision response to his/her application.
(m) Loan closing: the micro-branch 40 supports electronic documents for loan packages needed to dose approved loans. The documents should not be printed at the micro-branch 40; but can be accessed via a secure web portal, mailed from the credit union to the member, or picked up at a local branch of the credit union 6.
(n) Loan proceeds that don't require collateral documentation can be disbursed by the micro-branch 40 into a designated member share, provided such procedure is allowed by the core API aridfor policy of the credit union 6.
(o) New memberships: the micro-branch 40 can support any type of membership which is allowed by the credit union 6. Using ELLA 28 even the most complex account types can be opened successfully.
(p) Account management: credit union 6 members can manage essential information at the micro-branch 40, for example, based on credit union 6 policies, members can manage address changes at the micro-branch 40.

Additional financial processes performable at a micro-branch 40, in coordination with the Mosaic. Silhouette 1 system, and using the specific example of a credit union 6, are the following functions, (q), (r), and (s):
(q) A credit union 6 may minimize steps required for financial transactions by its members by means of a process termed “Member Pattern Recognition” (MPR), MPR monitors and tracks activity from each of the member-users 30 of the credit union 6. After a certain recurring transaction engaged in by the member 30 reaches a specific threshold of frequency of use, the concierge 29 will automatically inquire of the member whether he/she desires to engage in the certain recurring transaction, and if the answer is affirmative, MPR will complete the transaction for the member-user 30 with no further input required by the user 30.
(r) The Silhouette 1 system, using “Fraud Prevention Assistance” (FPA) software, will monitor and record ongoing activity by credit union 6 member-users 30 and gradually form a “baseline” of financial transaction activity for each user 30. Upon any financial activity by a member-user 30 that is skewed from this baseline, a message will appear on the concierge 29 display page indicating that unusual activity has been identified. This message serves only as a warning and no further action will be taken by Silhouette 1.
(s) A credit union 6. through the Silhouette software, may set a variety of pending events or conditions that will appear as a reminder(s) to a member 30 who logs in at a micro-branch 40. This process, known as Member Event Reminder (MER), includes, by way of example and not limitation, such matters as notification of a pending loan payment, maturation of a certificate of deposit, or approaching a specific limit for a share balance.

While preferred embodiments of the present inventive concept have been shown and disclosed herein, such embodiments are presented by way of example only, and not as a limitation to the scope of the inventive concept. Numerous variations, changes, and substitutions may occur or be suggested to those skilled in the art without departing from the intent, scope, and totality of this inventive concept. Accordingly, it is intended that this inventive concept be inclusive of such variations, changes, and substitutions, and is by no means limited by the scope of the claims presented herein.

What is claimed is:

1. A method for a customer or account holder of a financial. institution to operate any of a plurality of automated, video-teller machines for financial transactions, said machines being owned by the financial institution and installed at locations remote from the physical location of said financial institution or any of its physically structured branches, the method comprising the steps of:
providing the main branch of the financial institution with a primary front-end server capable of communicating with the internet and routing data packages to a variety of entities, including said remote video-teller machines;
providing a kiosk or similar structure to house said video-teller machine, as a micro-branch of the financial institution, said micro-branch having a means of direct communication with the primary server of said financial institution;
providing said micro-branch with application programming interface (API) for specific communication with a core platform/data processing system used by the financial institution;
providing, a touch-screen monitor with an opening home page displaying a one-page concierge screen seeking determination as to Whether the user accessing the micro-branch is a current customer or a new customer of the financial institution;
providing, upon a user selecting a: “member”/“customer” option on the monitor, an electronically loaded program for member/customer authentication:
determining, whether a new customer is accessing the micro-branch system, and thereupon displaying a series of sequential electronic screens for the purpose of registering the user as a financial institution customer and registering a password if the user is a first-time customer of the financial institution;
providing an overview page displaying tiles in a dashboard layout upon a user initiating access to any desired financial transaction as allowed by the core system of the financial institution;
providing an on-screen concierge which offers a variety of demographic profiles for guiding the user through a manually-selected transaction and its associated procedures;
providing capability for the micro branch unit to perform a plurality of transactions which include, minimally, cash deposits, cash withdrawal, check deposits, cashier check disbursements, loan payments, funds transfer between sub-accounts, stop payment (check), stop payment (ACH), account balance inquiries, loan balance inquiries, account details, loan details, signatures for required transactions, loan origination decisions, loan closings, loan proceeds disbursements, new customer processing, and account management.

2. The method of claim wherein the micro branch has, integrated within its API, software having the capability of
(a) minimizing steps required for financial transactions by customers by means of monitoring and tracking recurring activity by each customer, setting a specific threshold of frequency of use of said activity, and upon reaching said threshold, inquiring of the customer the desirability of engaging in the recurring activity, and if the answer is affirmative, automatically completing said transaction;
(b) utilization of a software program for “Fraud Prevention Assistance” whereby the primary front-end server monitors and records ongoing activity by customers, forms a “baseline” of financial transaction activity for each said customer user and upon a skewing from said baseline, displaying a message indicating that unusual activity has been identified; and
(c) setting a variety of pending events or conditions that will appear as an on-screen reminder(s) to a customer who logs in at a micro-branch, to include such matters as notification of a pending loan payment, maturation of a certificate of deposit, or approaching a specific limit for a share balance.

3. A method for a member or account holder of a credit union to operate an automated, video-teller machine for financial transactions, said machine being owned by the credit union and installed at a location remote from the physical location of said credit union or any of its physically structured branches, the method comprising the steps of:
providing the main branch of the credit union with a primary front-end server capable of communicating with the interact and routing data packages to a variety of entities, including said remote video-teller machines;
providing a kiosk or similar structure to house said video-teller machine as a micro-branch of the credit union, said micro-branch having a means of direct communication with the primary server of said credit union:
providing said micro-branch with application programming interface (API) for specific communication with a core platform/data processing system used by the credit union;
providing a touch-screen monitor with an opening home page displaying a one-page screen seeking determination as to whether a user accessing the micro-branch is a member or non-member of the credit union;
providing, upon the user selecting a “member” option on the monitor, an electronically loaded, program for member authentication;
displaying automatically, a series of sequential electronic screens for the purpose of registering the user as a credit union member and registering a password if the user is a first-time member of the credit union;
providing, an overview page displaying tiles in a dashboard layout upon a user initiating access to any desired financial transaction and its associated procedure, in conjunction with the credit union core system;
providing an on-screen concierge which offers a variety of demographic profiles for guiding the user through a manually-selected transaction and its associated procedures;
providing capability for the micro branch unit to perform financial transactions which include, minimally, cash deposits, cash withdrawal, check deposits, cashier check disbursements, loan payments, fluids transfer between sub-accounts, stop payment (check), stop payment (ACH), account balance inquiries, loan balance inquiries, account details, loan details, signatures for required transactions, loan origination decisions, loan closings, loan proceeds disbursements, new member processing, and account management.

4. The method of claim 3, wherein the micro branch has, integrated within its API, software having the capability of
(a) minimizing steps required for financial transactions by members by means of monitoring and tracking recurring; activity by each member, setting a specific threshold of frequency of use of said activity, and upon reaching said threshold, inquiring of the member the desirability of engaging in the recurring activity, and if the answer is affirmative, automatically completing said transaction;
(b) utilization of a software program for fraud prevention assistance whereby the primary front-end server monitors and records ongoing activity by members, forms a “baseline” of financial transaction activity for each said member user and upon a skewing from said baseline, displaying a message indicating that unusual activity has been identified; and
(c) setting a variety of pending events or conditions that will appear as an on-screen reminder(s) to a member who logs in at a micro-branch, to include such matters as notification of a pending loan payment, maturation of a certificate of deposit, or approaching a specific limit for a share balance.

5. An intuitive, interactive, automated video teller machine installed at a location remote from the physical location of a financial institution, or any of the financial institution's physically structured branches, said machine capable of performing a variety of financial transactions at the command of a user, said machine comprising:
a kiosk or similar structure to house said video-teller machine as a micro-branch of the financial institution, said micro-branch having a means of direct communication with the primary server of said financial institution;
application programming interface (API) for specific communication with a core platform/data processing system used. by the financial institution;
software which provides an on-screen concierge, such that there is offered a variety of demographic profiles for guiding a user through any manually-selected transaction and its associated procedures;
equipment which may include a printer, check scanner, video monitor, speaker, cash dispenser, bill acceptor, a printer discharge slot, a scanner input slot, magnetic ink character recognition (MICR), signature pads for supporting electronic signatures, and a video surveillance camera.

6. The video-teller machine of claim 5, further having internal software for performing a plurality of financial transactions, including cash deposits, cash withdrawal, check deposits, cashier check disbursements, loan payments, funds transfer between sub-accounts, stop payment (check), stop payment (ACH), account balance inquiries, loan balance inquiries, account details, loan details, signatures for required transactions, loan origination decisions, loan closings, loan proceeds disbursements, new member processing account management.

7. The video-teller machine of claim 5, wherein the micro branch has, integrated within its API, software having the capability of
(a) minimizing steps required for financial transactions by users by means of monitoring and tracking, recurring activity by each user, setting a specific threshold of frequency of use of said activity, and upon reaching said threshold, inquiring of the user the desirability of engaging in the recurring activity, and if the answer is affirmative, automatically completing said transaction;
(b) utilization of a software program for fraud prevention assistance whereby the primary front-end server monitors and records ongoing activity by users, forms a “baseline” of financial, transaction activity for each said user and upon a skewing from said baseline, displaying a message indicating that unusual activity has been identified; and
(c) setting a variety of pending events or conditions that will appear as an on-screen: reminder(s) to a user who logs in at a micro-branch, to include such matters as notification of a pending loan payment, maturation of a certificate of deposit, or approaching a specific limit for a share balance.
